(19) United States
(12) Patent Application Publication
(10) Pub. No.: US 2022/0048141 A1
(43) Pub. Date: Feb. 17, 2022

(54) METHOD OF PREPARING AN ALUMINUM METAL PIECE FOR WELDING

(71) Applicant: TWB COMPANY, INC., Monroe, MI (US)

(72) Inventors: Michael Telenko, Jr., Canton, MI (US); Sam A. Kassoumeh, Canton, MI (US)

(21) Appl. No.: 17/276,056

(22) PCT Filed: Sep. 17, 2019
(86) PCT No.: PCT/US2019/051526

§ 371 Date: Mar. 12, 2021

Related U.S. Application Data
(60) Provisional application No. 62/732,223, filed on Sep. 17, 2018.

(51) Int. Cl. B23K 26/402; B23K 26/082; B23K 26/0622; B23K 20/24

(52) U.S. Cl. CPC B23K 26/402; B23K 26/082; B23K 2101/34; B23K 20/24; B23K 26/0624

(57) ABSTRACT

A method of preparing aluminum metal pieces for welding, along with welded sheet metal assemblies formed from the prepared aluminum metal pieces. In one embodiment, a scanning beam of a laser is directed at an edge portion of the sheet metal piece such that a portion of the scanning beam is configured to impact an oxide layer at the edge portion. The laser is pulsed in a series of ablating pulses at the edge portion, with the ablating pulses creating an ablation plume that includes ablated material from the oxide layer of the primary surface and the peripheral surface of the edge portion. The ablation plume is analyzed, and ablation and analyzing continues until a threshold of at least one constituent in the ablation plume or the analysis plume is met or exceeded. One or more operating parameters of the laser are adjusted based on the analysis of the ablation plume or analysis plume. In some embodiments, two aluminum metal pieces are simultaneously prepared.

### CROSS-REFERENCE TO RELATED APPLICATIONS

This application claims the benefit of U.S. provisional application Ser. No. 62/732,223 filed on Sep. 17, 2018, the contents of which is hereby incorporated by reference in its entirety.

### FIELD

The present disclosure relates to welding metal pieces, and more particularly, to preparing aluminum-based sheet metal pieces for welding.

### BACKGROUND

There is a push in the automotive industry to use lighter weight materials for fuel economy purposes. Aluminum-based materials can be desirable alternatives to heavier steel materials. However, a naturally forming oxide layer forms on aluminum-based materials when the aluminum is exposed to the environment. The oxide layer may undesirably impact a weld joint in the aluminum-based sheet metal, particularly during a friction stir welding process. Minimizing oxide contamination of the weld joint is desirable.

### SUMMARY

In accordance with one embodiment, there is provided a method of preparing an aluminum metal piece for welding, the aluminum metal piece having an oxide layer, the method comprising the steps of: directing a beam of a laser at an edge portion of the aluminum metal piece such that a portion of the beam is configured to impact the oxide layer at the edge portion, wherein the edge portion includes at least a part of a primary surface of the aluminum metal piece, at least a part of a secondary surface of the aluminum metal piece, and at least a part of a peripheral surface of the aluminum metal piece, the peripheral surface being situated between the primary surface and the secondary surface; pulsing the laser in a series of cleaning pulses at the edge portion, wherein the cleaning pulses create a cleaning plume that includes ablated material from the oxide layer located at the primary surface and ablated material from the oxide layer located at the peripheral surface; analyzing the cleaning plume for the series of cleaning pulses or analyzing an analysis plume created by a series of analysis pulses at the edge portion; continuing the cleaning and analyzing step until a maximum threshold of aluminum in the cleaning plume or the analysis plume is met or exceeded; and correlating movement of the laser along the edge portion based on the analysis of the cleaning plume or analysis plume.

This method may further include one or more of the following steps or features, either individually or in combination as technically feasible:
the beam is a scanning beam, wherein the scanning beam of the laser comprises a 2-D scan or a 3-D scan having a non-uniform power distribution across the beam that is higher toward a central axis;
the scanning beam of the laser comprises a 2-D scan having an area of coverage that is between 200 mm×200 mm and 400 mm×400 mm, inclusive;
the scanning beam of the laser comprises a 3-D scan having a volume of coverage that is between 200 mm×200 mm×50 mm and 400 mm×400 mm×150 mm, inclusive;
the threshold of the at least one constituent is a maximum threshold of aluminum that is compared to a minimum threshold of oxygen;
the maximum threshold of aluminum is 500 counts per pulse and the minimum threshold of oxygen is 500 counts per pulse, and the cleaning and analyzing step continues until the aluminum is greater than 500 counts per pulse and the oxygen is less than 500 counts per pulse;
the threshold of the at least one constituent includes a threshold of magnesium, copper, manganese tin, silicon, and/or zinc, and wherein magnesium, copper, manganese tin, silicon, and/or zinc are included as one or more alloying elements in the base material layer;
the one or more operating parameters includes a power level, a pulse duration, a wavelength, a pulse frequency, a location, and/or a speed of the laser;
the oxide layer further includes other surface contaminants, and wherein the other surface contaminants includes organics, hydrocarbons, dirt, and/or oil;
the base metal layer has a thickness, and the edge portion after the cleaning and analysis step has a thickness, and wherein a difference between the thickness of the edge portion after the cleaning and analysis step and the thickness of the base metal layer is within 0.001-5%, inclusive;
the cleaning and analysis step results in total removal of the oxide layer at the edge portion to form an exposed subsurface of the base metal layer;
preparing a second aluminum metal piece for welding using the scanning beam of the laser on an edge portion of the second aluminum metal piece, wherein the preparing of the first aluminum metal piece and the preparing of the second aluminum metal piece occurs simultaneously;
welding the aluminum metal piece to a second aluminum metal piece at a weld joint along the edge region to form a welded sheet metal assembly;
forming the welded sheet metal assembly to create a formed portion, wherein the formed portion includes at least a portion of the weld joint;
the formed portion is free from joint line remnants;
an amount of cleaned oxide layer correlates with an average surface roughness of the aluminum metal piece at an electrical discharge textured portion;
the analyzing and cleaning step only partially removes the oxide layer; and/or
cleaning occurs at the primary surface, at the secondary surface, and at the peripheral surface.

According to another embodiment, there is provided a method of preparing first and second aluminum sheet metal pieces for welding, each of the first and second sheet metal pieces having an oxide layer, the method comprising the steps of: aligning the first aluminum sheet metal piece and the second aluminum sheet metal piece such that an edge portion of the first aluminum sheet metal piece faces an edge portion of the second aluminum sheet metal piece; directing a removal apparatus at the edge portions of the first and second aluminum sheet metal pieces such that a first portion of the removal apparatus is configured to impact the oxide layer at the edge portion of the first aluminum sheet metal piece and a second portion of the removal apparatus is configured to impact the oxide layer at the edge portion of the second aluminum sheet metal piece; and removing the oxide layer at the edge portion of the first aluminum sheet metal piece while removing the oxide layer at the edge portion of the second aluminum sheet metal piece until the oxide layer is removed from the edge portion of the first aluminum sheet metal piece and the oxide layer is removed from the edge portion of the second aluminum sheet metal piece.

This method may further include one or more of the following steps or features, either individually or in combination as technically feasible:
the removal apparatus is mechanical-based, coronal-based, plasma-based, laser-based, or chemical-based;
the removing step includes partial removal of the oxide layer of the first aluminum sheet metal piece and partial removal of the oxide layer of the second aluminum sheet metal piece;
the removing step is performed in conjunction with a welding step that welds the first and second aluminum sheet metal pieces;
the removing step includes total removal of the oxide layer to form an exposed subsurface on a base metal layer of the first aluminum sheet metal piece and total removal of the oxide layer to form an exposed subsurface on a base metal layer of the second aluminum sheet metal piece;
the removing step is performed in conjunction with a welding step that welds the first and second aluminum sheet metal pieces; and/or
the removing step comprises removing the oxide layer at a primary surface and a peripheral surface at the first aluminum sheet metal piece while removing the oxide layer at a primary surface and a peripheral surface at the second sheet metal piece.

According to another embodiment, there is provided a method of welding first and second aluminum sheet metal pieces, each of the first and second aluminum sheet metal pieces having an oxide layer, a primary surface, a secondary surface, and a peripheral surface between the primary and secondary surfaces, the method comprising the steps of: directing a removal apparatus at an edge portion of the first aluminum sheet metal piece such the removal apparatus is configured to impact the oxide layer at the edge portion; removing the oxide layer from the primary surface and the peripheral surface at the edge portion of the first aluminum sheet metal piece with the removal apparatus; removing the oxide layer from the secondary surface at the edge portion of the first aluminum sheet metal piece with the removal apparatus; removing the oxide layer from a weld portion of the primary surface of the second aluminum sheet metal piece with the removal apparatus; and welding the edge portion of the first aluminum sheet metal piece to the weld portion of the second aluminum sheet metal piece.

### DRAWINGS

FIG. 1 is an image showing oxide-related weld defects in an aluminum sheet metal piece;

FIG. 2 schematically illustrates a prepared aluminum sheet metal piece in accordance with one embodiment;

FIG. 3 is a cross-section view of the prepared sheet metal piece of FIG. 2;

FIG. 4 is a cross-section of the prepared sheet metal piece of FIG. 2 welded to another prepared sheet metal piece;

FIG. 5 illustrates another welding configuration that may be used with prepared sheet metal pieces;

FIG. 6 illustrates yet another welding configuration that may be used with prepared sheet metal pieces;

FIG. 7 schematically illustrates a method of laser cleaning an oxide layer in accordance with one embodiment;

FIG. 8 schematically illustrates a method of laser cleaning an oxide layer in accordance with another embodiment;

FIG. 9 is an example analysis spectrum before an oxide layer is fully cleaned;

FIG. 10 is an example analysis spectrum during the oxide cleaning process;

FIG. 11 is a cross-section of the welded sheet metal assembly of FIG. 4, after being subjected to a forming process; and

FIG. 12 is a cross-section of another welded sheet metal assembly.

### DESCRIPTION

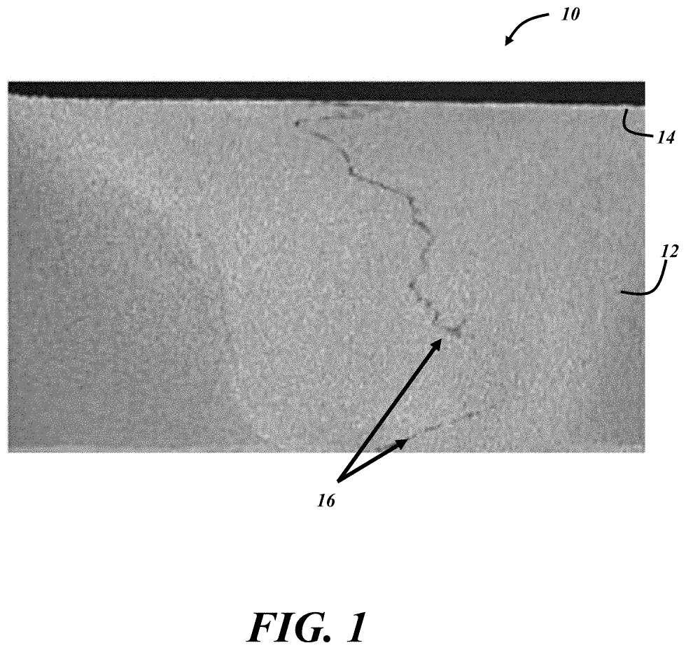

The methods described herein involve efficient and strategic removal of oxides from aluminum sheet metal pieces. Aluminum and its alloys are increasingly being used in automotive applications such as automotive body panels, automotive closures, automotive electric and hybrid vehicle body components, electric vehicle power storage and distribution components, and other structural components. Aluminum-based sheet metal pieces are frequently welded (e.g., to another aluminum-based sheet metal piece, sometimes being of a different aluminum grade). Welding aluminum-based can be difficult, and oftentimes, methods such as friction stir welding are employed. Before and during welding, the natural formation of an oxide layer occurs, which can result in oxides penetrating the weld joint. This can cause oxide-related weld defects, as shown in FIG. 1.

In FIG. 1, a sheet metal piece 10 includes a base metal layer 12 of aluminum or an aluminum-based alloy that includes a thin aluminum oxide layer 14. In this embodiment, oxide-related weld defects such as joint line remnants 16 have formed due to oxide contamination of a weld joint. Joint line remnants may be caused by inadequate removal of oxide from the aluminum base metal layer 12, or inadequate disruption and dispersal of oxide by the welding tool. Other defects may include voids, inadequately dispersed oxide, or root flaws, to cite a few examples. Targeted and efficient removal of oxides before welding can help abate the formation of these defects. Further, minimizing the oxide layer in accordance with the methods described herein can more precisely target the oxide layer while helping to maintain the structural integrity of the base metal layer and protecting the subsurface of the base metal layer.

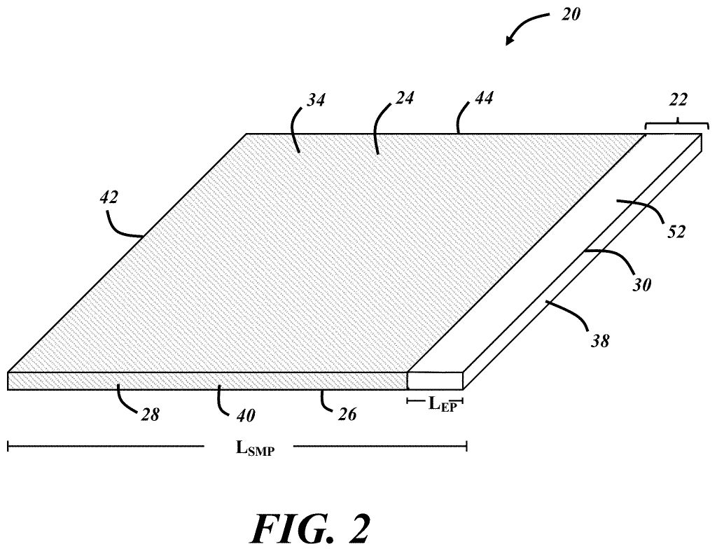

FIG. 2 illustrates a sheet metal piece 20 of aluminum or an aluminum alloy that is prepared in accordance with one embodiment and is to be welded to an adjacent piece along an edge portion 22. An “aluminum sheet metal piece” and/or an “aluminum metal piece,” as used herein, refer to a metal piece made from aluminum or an aluminum alloy (e.g., aluminum 2xxx, 5xxx, 6xxx, or 7xxx, to cite a few examples). The aluminum sheet metal piece 20 includes a primary surface 24, a secondary surface 26, and a peripheral surface 28 between the primary surface 24 and the secondary surface 26. The edge portion 22 is located along a welding edge 30 that is to be welded. The welding edge 30 may be straight as shown, or it may have another shape such as a curvilinear shape. The dimensions of the edge portion 22 may vary depending on the implementation. For example, the length L_{EP} of the edge portion 22 will likely be greater if a lap weld is desired than if a butt weld will be used. The length L_{EP} is typically much smaller than the length of the sheet metal piece (L_{SMP}). In some embodiments, an aluminum grain orientation in the aluminum metal piece 20 is oriented to possibly help limit oxide growth (e.g., grain surface area exposure is optimized along exposed surfaces 24, 26, and/or 28 through the use of certain cutting or forming methods).

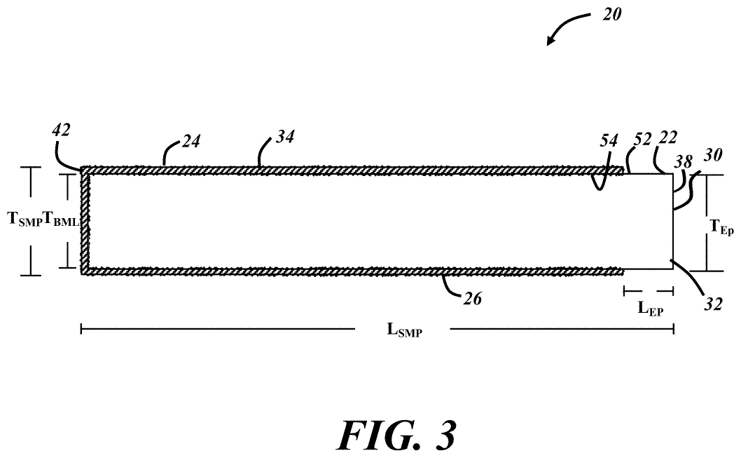

FIG. 3 is a schematic, cross-section of the aluminum sheet metal piece 20 of FIG. 2. The illustrated sheet metal piece 20 includes a base metal layer 32 and an oxide layer 34. The base metal layer 32 makes up the majority of the thickness of the sheet metal piece 20 (T_{SMP}) and thus contributes significantly to the mechanical properties of the sheet metal piece. As shown, the thickness of the base metal layer 32 (T_{BML}) is a large percentage of the overall thickness T_{SMP}. Moreover, the difference between the thickness at the edge portion 22 (T_{EP}) and the thickness of the base metal layer 32 (T_{BML}) can be minimized using the methods herein. In one example, the difference between T_{BML} and T_{EP} is about 0.001-5% (i.e., T_{EP} is within 0.001-5% of T_{BML}). In another example, the difference between T_{BML} and T_{EP} is about 0.001-2.5%. Maintaining this small difference between T_{BML} and T_{EP} helps promote structural integrity of the ultimately welded and formed part and protects the subsurface of the base metal layer 32. Additionally, the thickness T_{SMP} is small compared to the overall area of the primary and secondary surfaces 24, 26. This results in an area of a peripheral side (four peripheral sides 38-44 are shown in the figures, although other numbers or shapes are certainly possible) that is less than an area of the primary planar surface 24 or the secondary planar surface 26 by a factor of five or more.

The oxide layer 34 covers the base metal layer 32 and is then selectively cleaned from the edge portion 22. The oxide layer 34 is illustrated schematically as being generally planar, however, the surface of the oxide layer 34 is irregular and depends on respective oxide growth at different areas along the surfaces 24, 26, and 38-44 of the aluminum sheet metal piece 20. The oxide layer 34 may include aluminum oxide (Al₂O₃), oils, and/or other constituents. The oxide layer 34 may be naturally formed, or it could be formed purposefully on the sheet metal piece 20. For example, aluminum oxide, chromium oxide, and/or silicon dioxide may be formed (e.g., the oxide layer is deposited, or the sheet metal piece undergoes an anodizing process, or a pretreatment is applied, or an aluminum oxide stabilizer is applied) to help bolster wear and/or corrosion resistance. The ablation process may also serve to remove other surface contaminants that may be considered part of the oxide layer 34, such as organics, hydrocarbons, dirt and/or oil.

The base metal layer 32 is an aluminum metal piece. One specific example of a metal piece useful for forming body and structural components in the automotive and other industries, such as that shown in FIGS. 2 and 3, is the aluminum sheet metal piece 20 comprising 2xxx, 5xxx, 6xxx, 7xxx, or another operational grade aluminum. In some embodiments, the base metal layer 32 is a cast aluminum metal piece. Further, it is possible to have a welded assembly, comprising two aluminum metal pieces, each of which having a different material composition. For example, 5xxx grade aluminum sheet metal piece may be welded to a 6xxx grade sheet metal piece.

Example layer thicknesses range from about 0.5 mm to about 5.0 mm for the base metal layer 32, and from about 10 nm to about 100 μm for the oxide layer 34. A preferred material layer thickness for the base metal layer 32 is in a range from about 0.5 mm to about 2.0 mm. The thickness of the oxide layer 34 is highly variable as the layer grows upon exposure to oxygen, but growth typically slows exponentially as the layer gets thicker. The growth, thickness, and distribution of the oxide layer 34 depends on many variables such as the material of the base metal layer 32, storage, and handling. Of course, the example ranges provided above are non-limiting, as individual layer thicknesses depend on several factors specific to the application and/or the types of materials employed. Skilled artisans will also appreciate that the figures are not necessarily to scale and that the relative thicknesses of layers 32, 34 may differ from those illustrated in the drawings and described above.

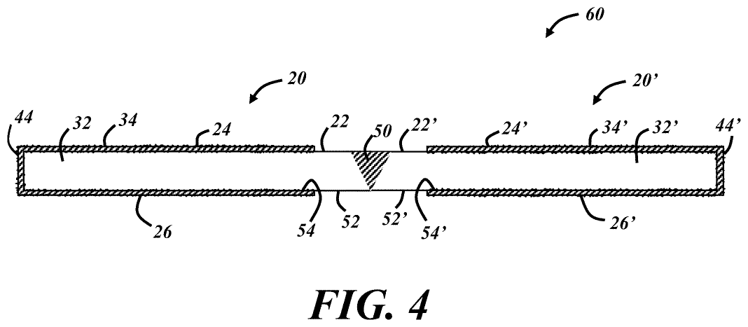

FIG. 4 shows the sheet metal piece 20, which is butt welded to a similar sheet metal piece 20′ at the weld joint 50. Removal of the oxides from the oxide layer 34 can form an exposed subsurface 52 of the base metal layer 32. Following some embodiments of the removal process, the exposed subsurface 52 is at least momentarily free from oxides from the oxide layer 34. Although the oxide layer 34 will quickly begin to reform, cleaning of all or part of the oxide layer 34 in accordance with the methods herein can help strategically minimize oxide contamination related defects in the final product. In some embodiments, a subsequent or contemporaneous welding process is carried out in conjunction with the cleaning and ablation process such that the welding step is carried out during a growth phase of the oxide layer 34 (e.g., before the exponential growth of the oxide layer 34, asymptotically approaches a stable thickness). Moreover, as detailed below, the exposed subsurface 52 is very close to the actual surface 54 of the base metal layer 32 that interfaces with the oxide layer 34. Minimizing the difference between the exposed subsurface 52 and the actual surface 54 can help maintain structural integrity of the welded sheet metal assembly 100. Maintaining the structural integrity by minimizing differences between the exposed subsurface 52 and/or the actual surface 54 (e.g., by minimizing the thickness difference between T_{BML} and T_{EP}) is balanced with the need to clean oxides from the edge portions 22, 22′ to help prevent oxide-related defects. Forming the exposed subsurface 52 is advantageous in a number of implementations; however, in some embodiments, ablation and removal may only be partial (e.g., about 5-99% of the oxide layer 34 is removed, or more preferably, 50-99%).

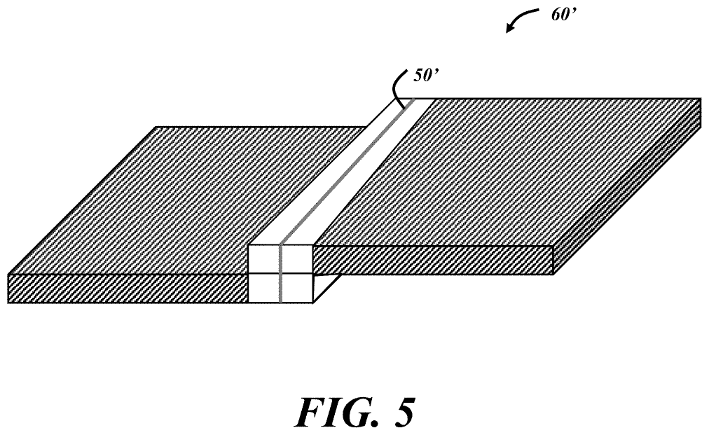

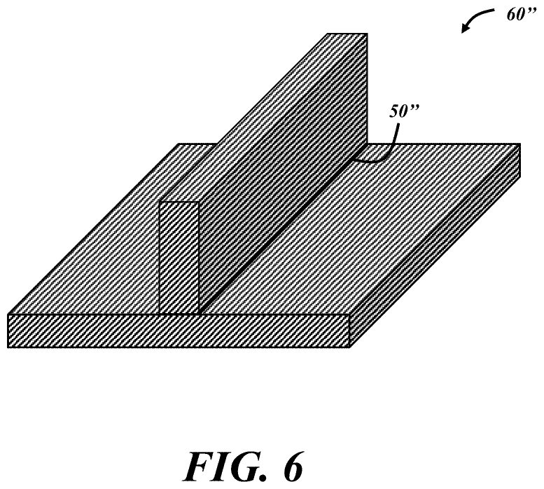

FIGS. 5 and 6 illustrate alternate welding configurations. FIG. 5 shows a welded sheet metal assembly 100′ having a weld joint 50′ in the form of a lap weld. In this embodiment, the surfaces may be prepared similarly to the embodiments of FIGS. 2 and 3. FIG. 6 shows a welded sheet metal assembly 100″ having two or more weld joints in the form of a fillet weld joint 50″ and a t-joint weld 51″. The welded assembly 100″ may have both joints 50″, 51″ or just one or the other of the joints 50″, 51″. The FIG. 6 embodiment also shows the reformed oxide layer after the surfaces have been cleaned and welded. Further, in this embodiment, the top sheet metal piece may be prepared similarly to the embodiments of FIGS. 2 and 3, but the bottom piece may only have a single cleaned surface along the middle of the piece. Other weld joints are certainly possible, such as a notch-based joint, as described for example, in U.S. application Ser. No. 16/320,370, which is assigned to the present Applicant, was filed on Jan. 24, 2019, and incorporated by reference herein in its entirety.

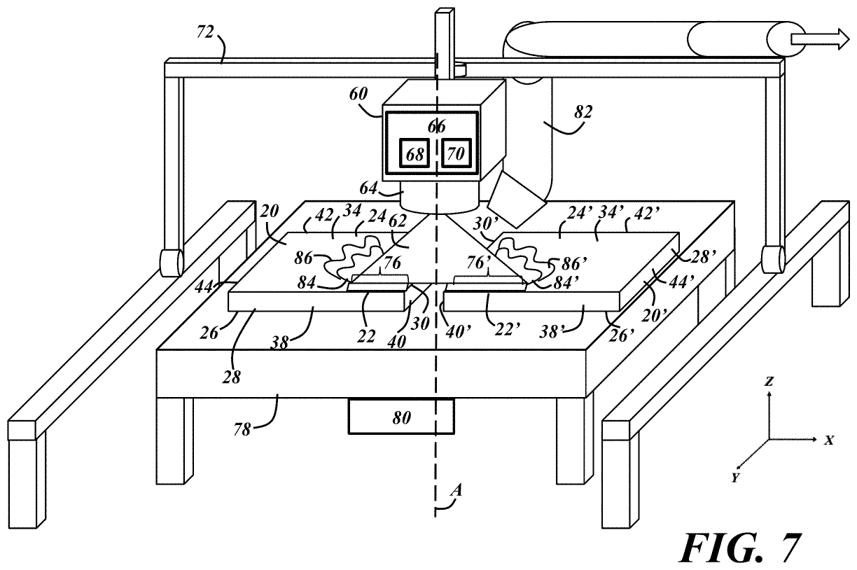

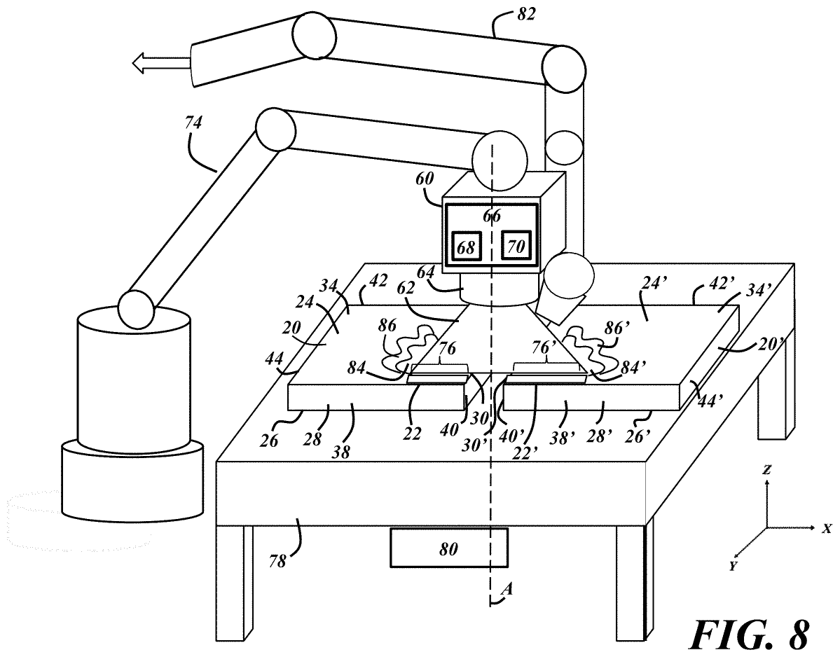

FIGS. 7 and 8 illustrate various embodiments of a method that may be used to achieve the balance between oxide removal from the oxide layer 34 while maintaining structural integrity at the edge portion 22. Given the non-uniformity of the oxide layer 34, strategic control of the cleaning process can help better protect the structural integrity of the underlying aluminum metal piece 20. Additionally, the oxide layer 34 has a higher melting temperature and is harder than the base metal layer 32. Given these qualities, the closed-loop monitoring aspect of the method described herein can help to more precisely control heat conduction in order to prevent adverse effects to the base metal layer 32. In this regard, the present method may be particularly advantageous when preparing tempered metals such as aluminum 6xxx series. Closed-loop automation allows for scalability of the method and provides for applicability to high volume manufacturing environments such as the automotive industry. Moreover, the elimination or substantial decrease in the likelihood of defect origination in weld joints formed after the cleaning method described herein can result in welded sheet metal pieces 20 that may be better able to withstand subsequent forming processes such as deep drawing. Accordingly, certain embodiments of the method can have mechanical strength that is comparable or better to manual cleaning methods but with less time and cost. Also, some embodiments of the described cleaning method can be more environmentally friendly and safer as compared to manual and chemical cleaning methods.

It should be noted that while the method is described in the context of preparing two aluminum sheet metal pieces 20, 20′ at the same time, whereas in some embodiments, only one sheet metal piece may be prepared at a time. In other embodiments, more than two sheet metal pieces may be prepared at a time. Preparing two metal pieces at a time, as described, can improve manufacturing efficiencies as compared with methods that prepare one metal piece at a time. Other processing steps may be included as well, besides what is particularly illustrated in FIGS. 7 and 8. For example, prior to cleaning, the aluminum metal piece may be subjected to electrical discharge texturing at the edge portion 22 (or across the entirety of the primary and secondary surfaces 24, 26), and an amount of cleaned oxide layer can then be correlated with an average surface roughness of the aluminum metal piece.

According to one embodiment, the method involves directing a removal apparatus 60 toward the edge portion 22 of the aluminum sheet metal piece 20. As shown in FIGS. 7 and 8, it is possible to align the first sheet metal piece 20 and the second sheet metal piece 20′ such that the edge portion 22 of the first sheet metal piece 20 faces the edge portion 22′ of the second sheet metal piece 20′. In other embodiments, however, there may be only one sheet metal piece. The removal apparatus 60 advantageously uses a scanning beam 62 of a laser delivery unit 64, but in other implementations, the removal apparatus may be a mechanical-based grinding or scraping tool. In yet other embodiments, the removal apparatus may be plasma-based, coronal-based, or chemical based. The laser delivery unit 64 may include a beam generator and an optical lens to deliver the laser beam in the intended configuration (e.g., by adjusting the focal height). The removal apparatus 60 in this embodiment includes a scan controller 66 which may also include an electronic processor 68 and memory 70. The removal apparatus 60 in the illustrated implementation also includes a beam generating unit which is not shown and can be remotely located, with a laser beam being delivered to the scan controller 66 through a laser fiber, to cite one example. The scan controller 66 can adjust the dimensions and various other properties of the scanning beam 62 during the cleaning process. For example, the scan controller 66 can control the shape of the beam 62 within the X-Y-Z coordinate plane. One advantage of a 3-D scanner is that both the horizontal and vertical surfaces of the sheet metal pieces 20, 20′ can be treated in one pass (e.g., the primary surface 24, 24′ and one or more of the peripheral sides 38-42). In other embodiments, a 2-D scan may be used. The area of coverage with a 2-D scan is about 300×300 mm in one embodiment, or anywhere between 200×200 mm and 400×400 mm, whereas the volume of a 3-D scan is about 300×300×100 mm, or anywhere between about 200×200×50 mm and 400×400×150 mm. These beam sizes can provide for better ablation or cleaning results given the spacing or gap between sheet metal pieces 20, 20′ and the desired size of the edge portions 22, 22′. Further, the beam sizes and/or shapes may be different than these particular examples, and in some embodiments, the cleaning accomplished with the scanning beam 62 may be done in conjunction with a welding or joining process to manufacture, for example, a welded assembly 100. In one particular embodiment, the cleaning may be done in conjunction or contemporaneously with a friction stir welding process, or some other fusion or solid-state welding process. The controller 66 can also be used to adjust various other operating parameters of the beam 62, such as the power, the pulse duration, the wavelength, the pulse frequency, and the location of the laser 64 (e.g., via linear speed of the gantry 72 of FIG. 7 or the robot 74 of FIG. 8). In one advantageous embodiment, the laser 64 is an ultra-fast pulsed laser (e.g., in the nanosecond, picosecond, or femtosecond range of pulses), although other laser types or removal apparatus types are certainly possible.

The removal apparatus 60 is directed at the first and second aluminum sheet metal pieces 20, 20′ such that a first portion 76 of the beam 62 is configured to impact the oxide layer 34 at the edge portion 22 of the first sheet metal piece 20. A second portion 76′ of the beam 62 is configured to impact the oxide layer 34′ at the edge portion 22′ of the second sheet metal piece 20′. The first and second portions 76, 76′ of the removal apparatus 60 are symmetrical along axis A. If the power distribution across the beam 62 is not entirely uniform (e.g., a Gaussian type distribution where the power is higher toward the axis or central axis A), it may be desirable for the power distribution to be symmetrical. This symmetry of the power distribution results in symmetrical first and second portions 76, 76′, which can in turn result in more uniform treatment of the first and second sheet metal pieces 20, 20′ during simultaneous processing. In some embodiments, a second laser or removal apparatus is used simultaneously on the other side or from the underside of the first laser to clean the secondary surface 26 at the same time as the primary surface 24 is being prepared.

Movement of the removal apparatus 60 relative to the aluminum sheet metal pieces 20, 20′ can be accomplished via the gantry 72 of FIG. 7 or the robot 74 of FIG. 8. In the illustrated embodiments, the sheet metal pieces 20, 20′ are stationary while the removal apparatus 60 is moved. The fixture table 78 can hold the sheet metal pieces 20, 20′ using mechanical, magnetic, or vacuum forces. A vacuum fixture 80 is advantageous over magnets as it can hold non-ferrous metals. Additionally, the vacuum fixture 80 may be advantageous over mechanical fixtures as it can provide a wider, more open area for the removal apparatus 60 to clean, as well as allowing for easier modification of the fixture table 78 in order to accommodate different product sizes and shapes. In another embodiment, moving tables or fixtures are used (e.g., facilitating linear or rotational movement of the sheet metal piece 20, 22′) while the removal apparatus remains stationary.

During the removal process, scanning beam 62 is configured to impact the oxide layer 34, 34′ at the edge portion 22, 22′. As will be detailed further below, various operating parameters may be adjusted during an in-line analysis to provide a better result where the oxide layer 34, 34′ is cleaned, while helping to maintain the structural integrity of the base metal layer 32, 32′. The oxide layer 34, 34′, in certain embodiments, is completely removed to form an exposed subsurface 52, 52′ on the base metal layer 32, 32′. This subsurface 52, 52′ may only briefly or momentarily be exposed, as the oxide layer 34, 34′ can quickly reform, but the cleaning process in general helps minimize oxide contamination related defects. Accordingly, the pieces 20, 20′ may be welded very soon after the cleaning process to help minimize these defects. The oxide layer 34, 34′ is preferably vaporized during the cleaning process and transported away from the sheet metal pieces 20, 20′ by the separation system 82. The separation system 82 may be a vacuum or another removal or transporting device that cleans the processing environment of fumes and ablated particles. Accordingly, the separation system 82 removes cleaned or ablated oxides from the area near the edge region 22, 22′.

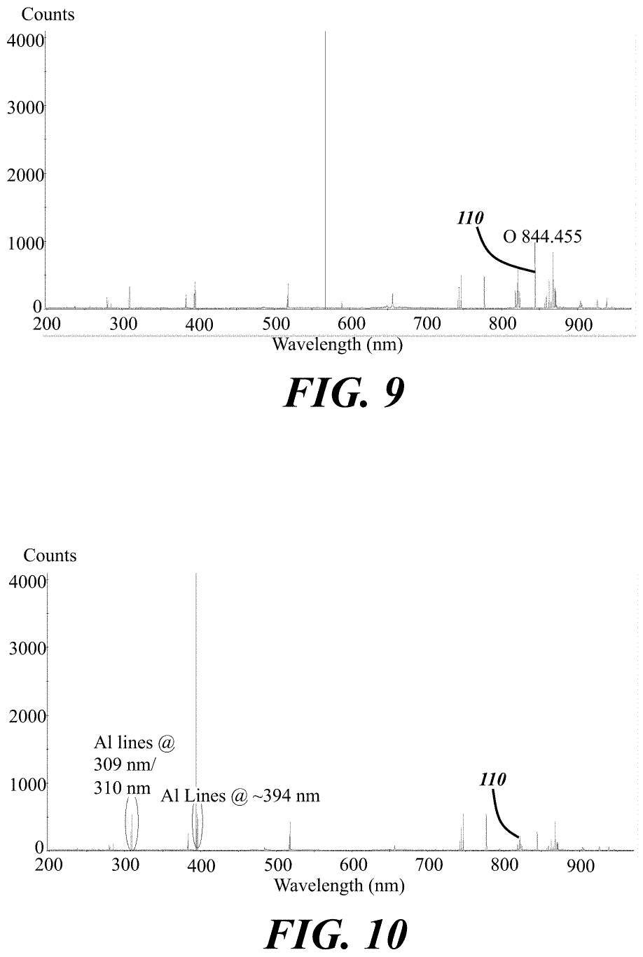

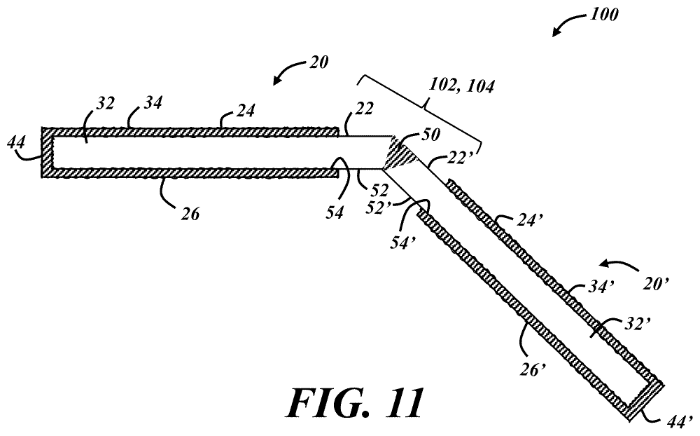

In an advantageous embodiment, the laser beam 62 is pulsed in a series of cleaning pulses at the edge portion 22, 22′. The cleaning pulses create a cleaning plume 84, 84′ which can then be analyzed and used to adjust one or more operating parameters of the removal apparatus 60. In some embodiments, a separate laser may be used to create an analysis plume that is created by a series of analysis pulses at the edge portion 22, 22′. In the illustrated embodiment, the same laser or removal apparatus 60 is used to both clean and analyze. The cleaning plume 84, 84′ and/or the analysis plume 86, 86′ is analyzed using a visual, laser, or plasma-based inspection system. In an advantageous embodiment, the cleaning plume 84, 84′ and/or the analysis plume 86, 86′ is analyzed using laser induced breakdown spectroscopy (LIBS) in which one or more pulses from laser beam 62 clean or ablate the oxide layer 34, 34′ and also generate an atomic emission from the ablated particles. A LIBS spectrum or spectra can provide concentration amounts (e.g., wt %) in the cleaning plume 84, 84′ and/or the analysis plume 86, 86′ which can then be used to adjust the operating parameters. The concentration amounts may be derived from a spectrum or spectra of intensity vs. wavelength. The analysis may be accomplished using scan controller 66 or another operable device. FIG. 9 is an example analysis spectrum showing a generally uncleaned oxide layer 34, and FIG. 10 is an example analysis spectrum showing a cleaned oxide layer 34. Given the presence of oxygen in the environment, it may be easier to base the analysis on the amount of aluminum, as the aluminum concentration will be higher when the base metal layer 32 is being ablated as opposed to the ablation or cleaning of the oxide layer 34. Accordingly, the example in FIG. 10 shows a strong Al line and a weaker oxygen (844) line 110, which may be indicative of a cleaned subsurface 52, 52′ (e.g., wherein the maximum threshold of aluminum is 500 counts per pulse and the minimum threshold of oxygen is 500 counts per pulse, and the ablation and analyzing step until the aluminum is greater than 500 counts per pulse and the oxygen is less than 500 counts per pulse). In another embodiment, Energy Dispersive Spectroscopy (EDS) is used in the analyzing step.

In one example, the analyzing step continues until a threshold of at least one constituent in the cleaning plume 84, 84′ and/or the analysis plume 86, 86′ is met or exceeded. In one particular embodiment, the analyzing step continues until a minimum threshold of aluminum in the cleaning plume 84, 84′ and/or the analysis plume 86, 86′ is met or exceeded. At that point, one or more operating parameters can be adjusted, such as moving the laser beam 62 along the edge portion 22, 22′. The minimum threshold of may be a calibratable threshold depending on the composition of the base metal layer 32 (e.g., a higher concentration of aluminum in the alloy will result in a lower minimum threshold because the aluminum is more likely to spike sooner given the higher concentration). The threshold may also be dependent on the parameters of the laser and/or the desired form of the exposed subsurface 52, 52′ at the edge portion 22, 22′. For example, it is likely that a minimal amount of the oxide layer 34, 34′ will be ablated nearest the inboard portion of the edge portion 22, 22′ (e.g., nearest the outer angled edges of the scanning beam 62), while it is completely removed to momentarily expose the base metal layer 32, 32′ nearest edge 30, 30′. In other embodiments, the analysis may focus on an amount of an alloying element in the base metal layer 32, 32′ such as magnesium, copper, manganese, tin, silicon, or zinc, to cite a few examples. The analysis may focus on a combination of constituents in the cleaning plume 84, 84′ and/or the analysis plume 86, 86′. For example, the analysis may continue until a minimum threshold of aluminum is met while a maximum threshold of oxygen is met. These thresholds may be adjusted based on the laser operating parameters, the qualities of the operating environment, as well as the composition of the various layers 32, 34.

Based on the analysis of the cleaning plume 84, 84′ and/or the analysis plume 86, 86′, one or more operating parameters of the removal apparatus 60 can be adjusted. In one embodiment, the operating parameters include the power, the pulse duration, the wavelength, the pulse frequency, and the location or speed of the laser 64. In one embodiment, the power range is in the range of approximately 10-5000 W, with one example baseline or average being 800 W. In one embodiment, the pulse duration is in the range of approximately 1-100 nsec, with one example baseline or average being 25 nsec. Adjustments can be made accordingly if the pulse duration is in the picosecond range, femtosecond range, or some other operable duration. In one embodiment, the wavelength is in the range of approximately 850-1200 nm, with one example baseline or average being 1030 nm. In one embodiment, the pulse frequency is in the range of approximately 5-100 kHz, with one example baseline or average being 30 kHz. In one embodiment, the linear speed of the gantry 72 or robot 74 is in the range of approximately 1-25 m/min, with one example baseline or average being 6 m/min.

Feedback from the analysis may be used to adjust the operating parameters of the removal apparatus 60. For example, the amount of aluminum may be monitored and the speed or position of the laser 64 may be dependent on whether the threshold minimum amount of aluminum is present or exceeded. Until the threshold amount of aluminum is reached, the laser may maintain a certain position or may proportionally slow the speed of the gantry 72 or robot 74. In another example, the power may be increased proportionally depending on the presence or absence of one or more constituents. In yet another example, the wavelength may be adjusted. For example, ablation of both aluminum and aluminum oxide may be more effective at a particular wavelength, whereas the ablation of aluminum may be less effective at another wavelength. As the amount of aluminum oxide decreases, the wavelength of the laser may be adjusted to the wavelength that is less effective at ablating aluminum in order to preserve the structural integrity of the base metal layer 32, 32′. In yet another example, the pulse duration or pulse frequency may be adjusted. For example, the pulse duration or pulse frequency may be proportionally lessened as the aluminum concentration increases. Other example adjustments are certainly possible. Adjustment of the operating parameters using the feedback analysis described herein can more precisely clean oxides from the oxide layer 34, 34′ and form the exposed subsurface 52, 52′ of the base metal layer 32, 32′.

After the sheet metal pieces 20, 20′ are prepared, they can be welded at the edge portion 22, 22′ as illustrated in FIGS. 4-6. In some embodiments, a one-piece or small batch flow is used, where a friction stir welding process joins pieces 20, 20′ after cleaning. Timing between the cleaning method and welding may be seconds or minutes, as in this time frame, growth of the oxide layer 34, 34′ will be minimal. With oxides from the oxide layer 34, 34′ removed, oxide contamination related defects can be prevented or minimized during the welding process and the welded assembly can maintain its structural integrity during subsequent forming processes such as stamping or drawing. Moreover, the weld may be stronger since more of the base metal layer 32, 32′ is available at the edge portion 22, 22′.

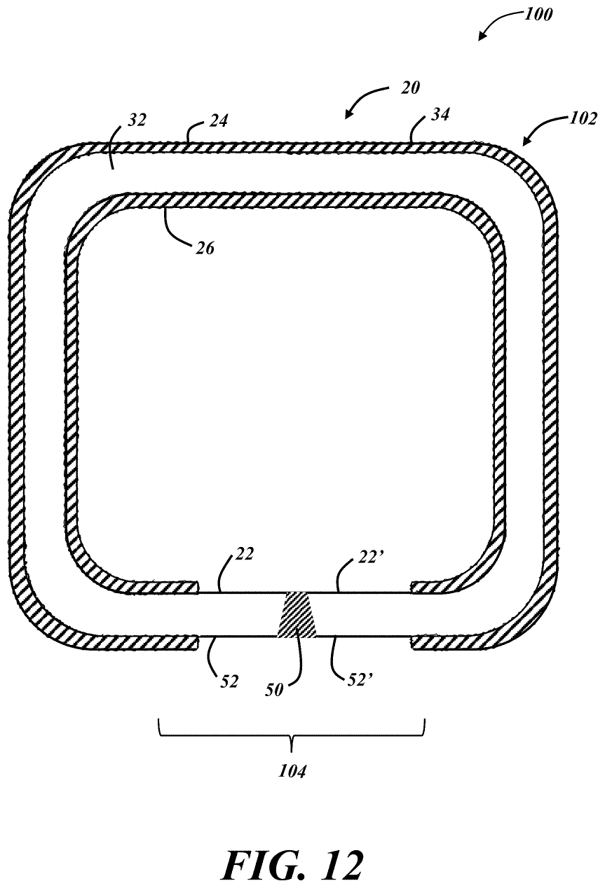

FIGS. 11 and 12 schematically illustrate example welded sheet metal assemblies 100 that include a formed portion 102 formed via a forming process such as hot stamping, cold stamping, drawing, etc. The welded sheet metal assemblies 100 may be automotive body panels, automotive closures, automotive electric and hybrid vehicle body components, or electric vehicle power storage and distribution components, to cite a few examples. The formed portion 102 can be formed along the weld joint 50, such as the bend shown in FIG. 11, although in other embodiments, it is likely that the formed portion only crosses a portion of the weld joint 50. In FIG. 12, the welded assembly 100 is made from only a single piece 20 that includes two edge portions 22, 22′ that are welded together. The welded assembly 100 may be a battery box, or some other structure that is desirably formed from one piece that is welded together at two edge portions 22, 22′ that are cleaned in accordance with the methods described herein. The welded assembly 100 may be more of a tube-shape, which could be desirable in applications such as cross car beams. Due to the preparation and removal methods described herein, a cleaned portion 104, and in some embodiments, the formed portion 102 as well, are free from residual stresses resulting from discontinuities in the weld, such as joint line remnants that propagate into the base metal layer 32, 32′. In some embodiments as well, the portion 104 may correspond to an area that has been texturized with electrical discharge texturizing.

It is to be understood that the foregoing description is not a definition of the invention, but is a description of one or more exemplary illustrations of the invention. The invention is not limited to the particular example(s) disclosed herein, but rather is defined solely by the claims below. Furthermore, the statements contained in the foregoing description relate to particular exemplary illustrations and are not to be construed as limitations on the scope of the invention or on the definition of terms used in the claims, except where a term or phrase is expressly defined above. Various other examples and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A method of preparing an aluminum metal piece for welding, the aluminum metal piece having an oxide layer, the method comprising the steps of:
directing a beam of a laser at an edge portion of the aluminum metal piece such that a portion of the beam is configured to impact the oxide layer at the edge portion, wherein the edge portion includes at least a part of a primary surface of the aluminum metal piece, at least a part of a secondary surface of the aluminum metal piece, and at least a part of a peripheral surface of the aluminum metal piece, the peripheral surface being situated between the primary surface and the secondary surface;
pulsing the laser in a series of cleaning pulses at the edge portion, wherein the cleaning pulses create a cleaning plume that includes ablated material from the oxide layer located at the primary surface and ablated material from the oxide layer located at the peripheral surface;
analyzing the cleaning plume for the series of cleaning pulses or analyzing an analysis plume created by a series of analysis pulses at the edge portion;
continuing the cleaning and analyzing step until a maximum threshold of aluminum in the cleaning plume or the analysis plume is met or exceeded; and
correlating movement of the laser along the edge portion based on the analysis of the cleaning plume or analysis plume.

2. The method of claim 1, wherein the beam is a scanning beam, and the scanning beam of the laser comprises a 2-D scan or a 3-D scan having a non-uniform power distribution across the beam that is higher toward a central axis.

3. The method of claim 2, wherein the scanning beam of the laser comprises a 2-D scan having an area of coverage that is between 200 mm×200 mm and 400 mm×400 mm, inclusive.

4. The method of claim 2, wherein the scanning beam of the laser comprises a 3-D scan having a volume of coverage that is between 200 mm×200 mm×50 mm and 400 mm×400 mm×150 mm, inclusive.

5. The method of claim 1, wherein the threshold of the at least one constituent is a maximum threshold of aluminum that is compared to a minimum threshold of oxygen.

6. The method of claim 5, wherein the maximum threshold of aluminum is 500 counts per pulse and the minimum threshold of oxygen is 500 counts per pulse, and the cleaning and analyzing step continues until the aluminum is greater than 500 counts per pulse and the oxygen is less than 500 counts per pulse.

7. The method of claim 1, wherein the threshold of the at least one constituent includes a threshold of magnesium, copper, manganese tin, silicon, and/or zinc, and wherein magnesium, copper, manganese tin, silicon, and/or zinc are included as one or more alloying elements in the base material layer.

8. The method of claim 1, wherein the one or more operating parameters includes a power level, a pulse duration, a wavelength, a pulse frequency, a location, and/or a speed of the laser.

9. The method of claim 1, wherein the oxide layer further includes other surface contaminants, and wherein the other surface contaminants includes organics, hydrocarbons, dirt, and/or oil.

10. The method of claim 1, wherein the base metal layer has a thickness, and the edge portion after the cleaning and analysis step has a thickness, and wherein a difference between the thickness of the edge portion after the cleaning and analysis step and the thickness of the base metal layer is within 0.001-5%, inclusive.

11. The method of claim 1, wherein the cleaning and analysis step results in total removal of the oxide layer at the edge portion to form an exposed subsurface of the base metal layer.

12. The method of claim 1, further comprising the step of preparing a second aluminum metal piece for welding using the scanning beam of the laser on an edge portion of the second aluminum metal piece, wherein the preparing of the first aluminum metal piece and the preparing of the second aluminum metal piece occurs simultaneously.

13. The method of claim 1, further comprising the step of welding the aluminum metal piece to a second aluminum metal piece at a weld joint along the edge region to form a welded sheet metal assembly.

14. The method of claim 13, further comprising the step of forming the welded sheet metal assembly to create a formed portion, wherein the formed portion includes at least a portion of the weld joint.

15. The method of claim 14, wherein the formed portion is free from joint line remnants.

16. The method of claim 1, wherein an amount of cleaned oxide layer correlates with an average surface roughness of the aluminum metal piece at an electrical discharge textured portion.

17. The method of claim 1, wherein the analyzing and cleaning step only partially removes the oxide layer.

18. The method of claim 1, wherein cleaning occurs at the primary surface, at the secondary surface, and at the peripheral surface.

19. A method of preparing first and second aluminum sheet metal pieces for welding, each of the first and second sheet metal pieces having an oxide layer, the method comprising the steps of:
aligning the first aluminum sheet metal piece and the second aluminum sheet metal piece such that an edge portion of the first aluminum sheet metal piece faces an edge portion of the second aluminum sheet metal piece;
directing a removal apparatus at the edge portions of the first and second aluminum sheet metal pieces such that a first portion of the removal apparatus is configured to impact the oxide layer at the edge portion of the first aluminum sheet metal piece and a second portion of the removal apparatus is configured to impact the oxide layer at the edge portion of the second aluminum sheet metal piece; and
removing the oxide layer at the edge portion of the first aluminum sheet metal piece while removing the oxide layer at the edge portion of the second aluminum sheet metal piece until the oxide layer is removed from the edge portion of the first aluminum sheet metal piece and the oxide layer is removed from the edge portion of the second aluminum sheet metal piece.

20. The method of claim 19, wherein the removal apparatus is mechanical-based, coronal-based, plasma-based, laser-based, or chemical-based.

21. The method of claim 19, wherein the removing step includes partial removal of the oxide layer of the first aluminum sheet metal piece and partial removal of the oxide layer of the second aluminum sheet metal piece.

22. The method of claim 21, wherein the removing step is performed in conjunction with a welding step that welds the first and second aluminum sheet metal pieces.

23. The method of claim 19, wherein the removing step includes total removal of the oxide layer to form an exposed subsurface on a base metal layer of the first aluminum sheet metal piece and total removal of the oxide layer to form an exposed subsurface on a base metal layer of the second aluminum sheet metal piece.

24. The method of claim 23, wherein the removing step is performed in conjunction with a welding step that welds the first and second aluminum sheet metal pieces.

25. The method of claim 19, wherein the removing step comprises removing the oxide layer at a primary surface and a peripheral surface at the first aluminum sheet metal piece while removing the oxide layer at a primary surface and a peripheral surface at the second sheet metal piece.

26. A method of welding first and second aluminum sheet metal pieces, each of the first and second aluminum sheet metal pieces having an oxide layer, a primary surface, a secondary surface, and a peripheral surface between the primary and secondary surfaces, the method comprising the steps of:
directing a removal apparatus at an edge portion of the first aluminum sheet metal piece such the removal apparatus is configured to impact the oxide layer at the edge portion;
removing the oxide layer from the primary surface and the peripheral surface at the edge portion of the first aluminum sheet metal piece with the removal apparatus;
removing the oxide layer from the secondary surface at the edge portion of the first aluminum sheet metal piece with the removal apparatus;
removing the oxide layer from a weld portion of the primary surface of the second aluminum sheet metal piece with the removal apparatus; and
welding the edge portion of the first aluminum sheet metal piece to the weld portion of the second aluminum sheet metal piece.
